(19) United States
(12) Patent Application Publication
(10) Pub. No.: US 2008/0142299 A1
(43) Pub. Date: Jun. 19, 2008

(54) Foot Apparatus for Ladder Stand

(76) Inventor: Ronald L. Berkbuegler, Troy, IL (US)

Correspondence Address: SENNIGER POWERS LLP, ONE METROPOLITAN SQUARE, 16TH FLOOR, ST LOUIS, MO, 63102, US

(21) Appl. No.: 11/610,844

(22) Filed: Dec. 14, 2006

(51) Int. Cl. E06C 7/42

(52) U.S. Cl. 182/108

(57) ABSTRACT

A foot apparatus for a ladder stand includes an arcuate bar and a pair of connector for securing the foot apparatus to the ladder stand. The connectors are slidable along the arcuate bar to adjust the angle at which the ladder stand extends from the foot apparatus and to accommodate ladders of different widths. Opposite ends of the arcuate bar are beveled to facilitate penetration of the foot apparatus in a support surface. A cross bar is secured to the arcuate bar to provide support to the arcuate bar. A fastening device releasably secures the foot apparatus to the ladder stand.

### FIELD OF THE INVENTION

The present invention generally relates to a foot apparatus for a ladder stand, and more particularly to a foot apparatus including an arcuate bar and a connector slidably secured to the arcuate bar.

### BACKGROUND OF THE INVENTION

Ladder stands permit a hunter to climb up a tree to a location above his game. In general, ladder stands include a rigid ladder and a platform extending rearward from an upper portion of the ladder. To properly and safely erect the ladder stand, feet of the ladder stand are placed near the base of the tree so that the ladder extends upward along the height of the tree, generally in alignment with the tree, and the platform at the top of the ladder engages the trunk of the tree. The platform and the ladder portion of the ladder stand are secured to the trunk of the tree.

Most ladder stands have feet that allow the ladder to extend only at an angle that is perpendicular to the ground. That is, the user cannot adjust the angle at which the ladder extends from the ground. As a consequence, if a tree is on a sloped terrain but extends generally upright, the user will not be able to extend the ladder upward along the height of the tree, and therefore, the user will not be able to properly and safely erect the ladder stand. Moreover, if the terrain is level but the tree extends from the terrain at an angle, the use will not be able to extend the ladder upward along the height of the tree, and therefore, the user will not be able to properly and safely erect the ladder stand. Typically, in order to properly and safely erect the ladder stand, the user must find both a level terrain and a tree that extends generally perpendicular to the terrain (i.e., a tree having a straight trunk). Most of the time, finding both a straight tree and a level terrain is difficult.

In addition, most ladder stands include hollow stiles with open bottom portions. When the user is erecting the stand, he or she may force the bottom portions of the stiles into the ground to prevent the ladder from moving. Forcing the stiles into the ground plugs the open bottoms of the stiles with dirt. The dirt plugs in the stiles prevent condensation and other moisture inside the stiles from exiting. The moisture in the stiles accumulates at the bottom portions of the stiles and may freeze and expand rapidly, damaging and leading to failure of the stiles.

### SUMMARY OF THE INVENTION

In one aspect of the present invention, a foot apparatus for a ladder stand generally comprises an arcuate bar having opposite ends for engaging a support surface. At least one connector is slidably secured to the arcuate bar for connecting the arcuate bar to a bottom portion of the ladder stand. The connector is slidable along the arcuate bar so that when the foot apparatus is attached to the ladder stand, the ladder stand extends at a selected angle with respect to the support surface. A cross bar having opposite ends is secured generally adjacent to said opposite ends of the arcuate bar.

In another aspect, a foot apparatus for a ladder stand generally comprises an arcuate bar having opposite ends shaped for penetrating support surface. At least one connector is slidably secured to the arcuate bar for connecting the arcuate bar to a bottom portion of the ladder stand. The connector is slidable along the arcuate bar so that when the foot apparatus is attached to the ladder stand, the ladder stand extends at a selected angle with respect to the support surface.

In yet another aspect, a foot apparatus for a ladder stand of the type including a pair of stiles each having an axial cavity formed in at least a bottom portion thereof generally comprises an arcuate bar. A pair of connectors for securing the arcuate bar to a bottom portion of the ladder stand each includes a bracket member for being secured to the arcuate bar for selective sliding movement along the bar. An extension member extends from the bracket member and is sized and shaped to be received in the cavities of the bottom portions of the stiles of the ladder stand.

Other features will be in part apparent and in part pointed out hereinafter.

### BRIEF DESCRIPTION OF THE DRAWINGS

FIG. 1 is a perspective of one embodiment of a foot apparatus;

FIG. 2 is a perspective of a ladder stand including the foot apparatus of FIG. 1 against a tree;

FIG. 3 is an enlarged fragmentary front elevation of a bottom portion of the ladder stand of FIG. 2;

FIG. 4 is similar to FIG. 3 with the foot apparatus exploded from the ladder stand and a portion of a ladder of the ladder stand broken away;

FIG. 5 is a perspective of a connector of the foot apparatus;

FIG. 6 is a front elevation of the connector;

FIG. 7 is a front elevation of the foot apparatus engaging sloped ground;

FIG. 8 is an enlarged fragmentary front elevation of a ladder stand similar to the ladder stand of FIG. 2, except that a width of a ladder of the ladder stand is less than a width of a ladder of the ladder stand in FIG. 2;

FIG. 9 is a front elevation of the foot apparatus with the connectors removed;

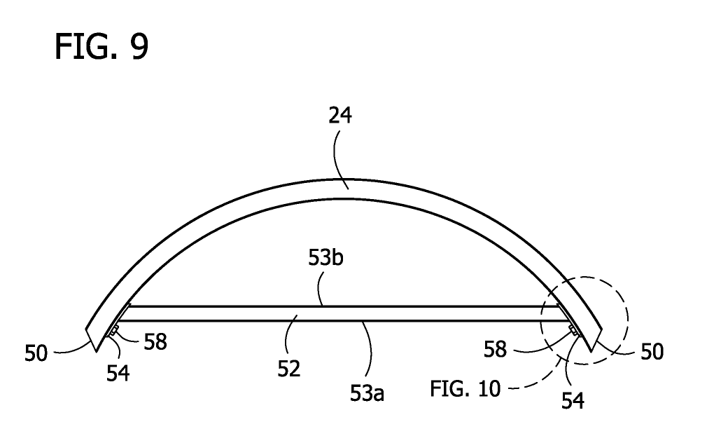

FIG. 10 is a detail of the right end of the foot apparatus of FIG. 9; and

FIG. 11 is a perspective of the foot apparatus of FIG. 9 with a cross bar exploded from an arcuate bar.

Corresponding reference characters indicate corresponding parts throughout the drawings.

### DETAILED DESCRIPTION OF THE DRAWINGS

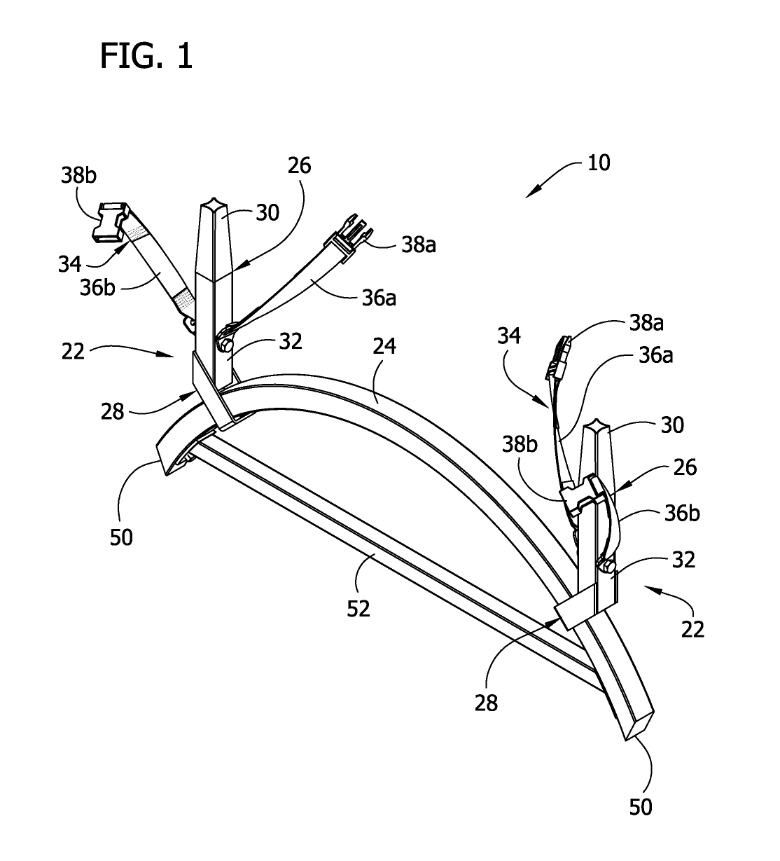

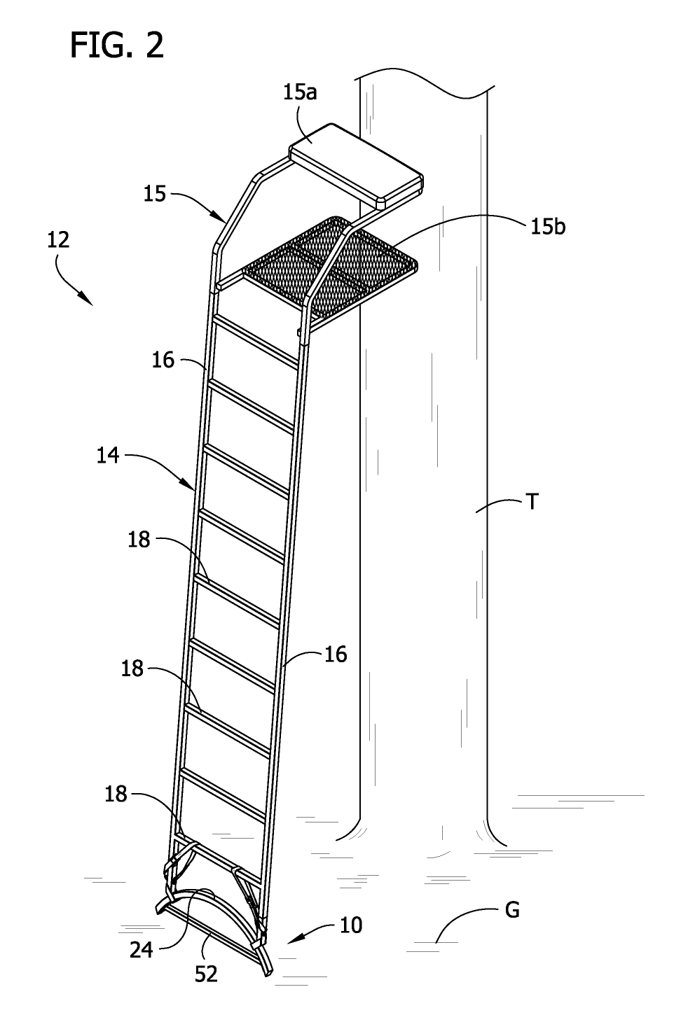

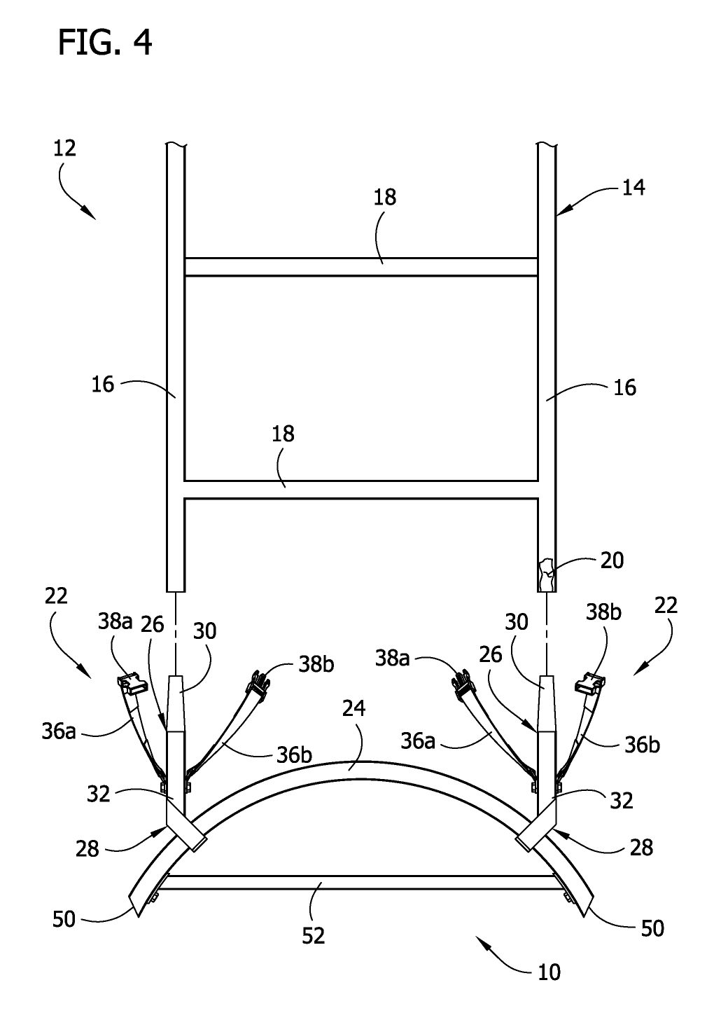

Referring now to the drawings, and in particular to FIGS. 1 and 2, one embodiment of a foot apparatus for a ladder stand is generally indicated at 10. In general, the foot apparatus is adapted to be secured to a bottom portion of a ladder stand. An example of a ladder stand for use with the foot apparatus is generally indicated at 12 in FIG. 2. Referring to FIG. 2, the ladder stand 12 includes a ladder, generally indicated at 14, and a platform, generally indicated at 15, extending rearward from an upper portion of the ladder. The ladder 14 includes pair of parallel stiles 16 and a plurality of rungs 18 secured along lengths of the stiles. The stiles 16 and the rungs 18 have a rectangular cross-section, although it is understood that the stiles and rungs may have other cross-sectional shapes, such as circular. The stiles 16 are hollow so that bottom portions of the stiles are open and define an axial cavity 20 therein (FIG. 4, only one is shown). The platform 15 includes a seat 15a and a foot rest 15b, although other arrangements are within the scope of the invention. As used herein for the broadest scope of the invention, a ladder stand includes ladders that do not have a platform. The ladder stand also includes a securement system (not shown) for securing the ladder stand 12 to a tree T. In use, the foot apparatus 10 engages ground G (broadly, a support surface).

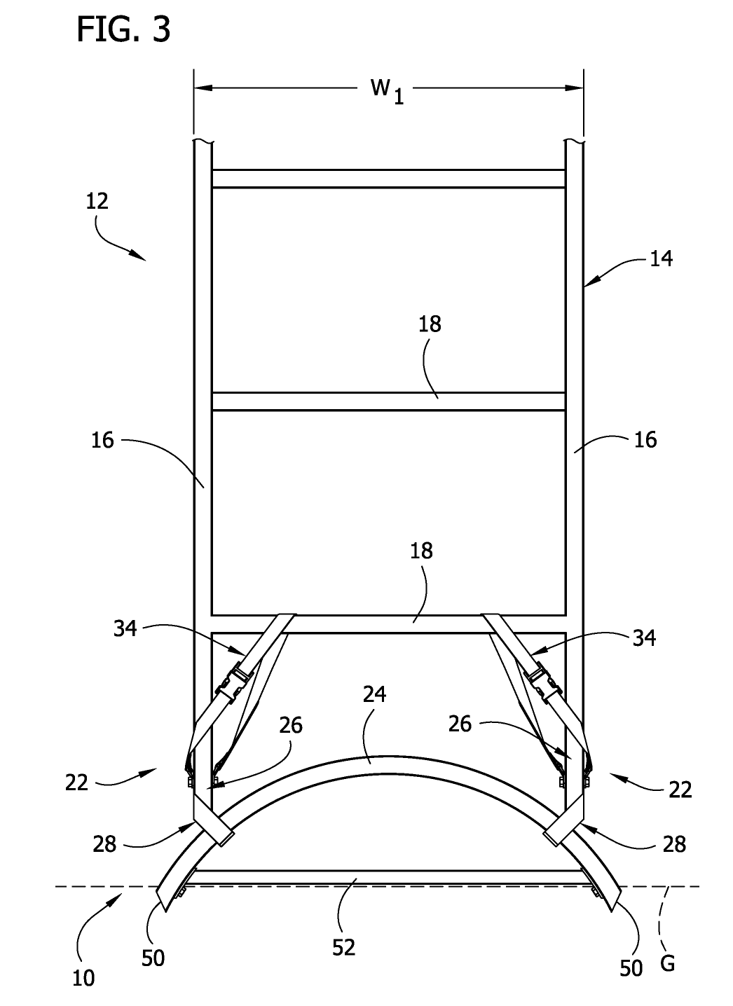

Referring now to FIGS. 1 and 3-6, the foot apparatus 10 includes a pair of connectors, generally indicated at 22, slidably received on an arcuate bar 24. Each connector 22 includes an extension member, generally indicated at 26, secured at one end to a bracket member, generally indicated at 28. As shown best in FIGS. 3 and 4, the extension member 26 is sized and shaped to fit within the axial cavity 20 of the bottom portion of one of the stiles. More particular, the extension member 26 has a tapered portion 30 (broadly, a first portion; FIGS. 4-6) that includes a free end of the extension member. The tapered portion 30 tapers toward the free end of the extension member 26 to facilitate insertion of the extension member into the axial cavity 20 of the stile 16. A second portion 32 (FIGS. 4-6) of the extension member 26 has a cross-sectional shape that is larger than the cross-sectional shape of the axial cavity 20 to function as a stop of the extension member. It is understood that the foot apparatus 10 may be integrally formed on the ladder stand 12 within the scope of the invention. For example, one embodiment of the connectors (not shown) may include only bracket members welded directly to the stiles 16 of the ladder 14. Other ways of connecting the foot apparatus to the ladder stand are within the scope of the invention.

In the illustrated embodiment, the extension members 26 are formed from hollow bar stock having similar rectangular cross-sections of the stiles. Ends of the extension members 26 are open so that moisture inside the stiles 16 can travel out of the stiles and through the extension members. The tapered portions 30 are formed by swaging the free end margins of the extension members 26. Other ways of forming the extension members 26 are within the scope of the invention. Moreover, other ways of attaching the connectors 22 to the ladder 14 is contemplated. For example, the extension members 26 may be constructed for securement to an exterior of the stiles 16. Other ways of attaching the connector to the ladder are within the scope of the invention.

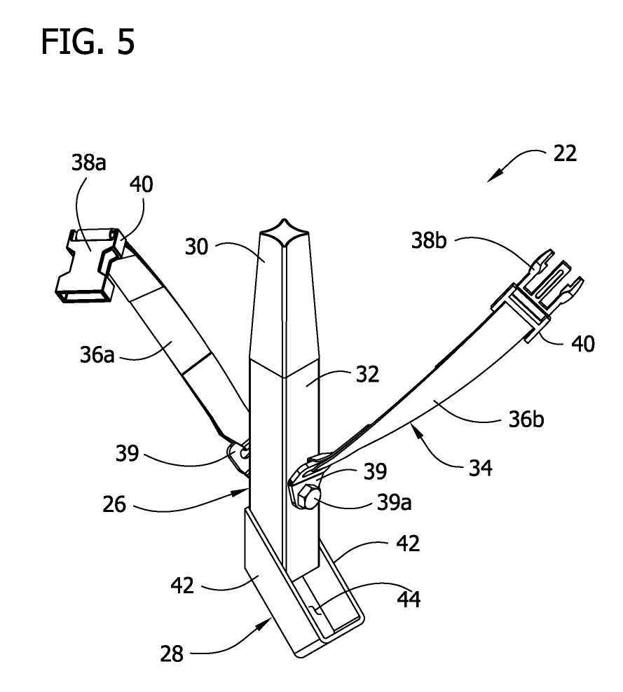

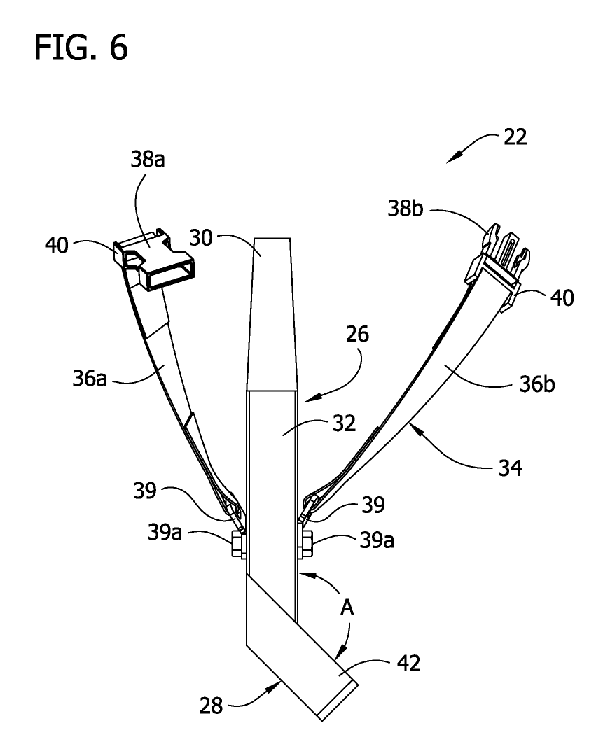

Referring still to FIGS. 1 and 3-6, the foot apparatus 10 includes a pair of strap assemblies (broadly, a fastening device), each generally indicated at 34, for holding the extension members 26 in the cavities 20 of the stiles 16 during use. The strap assemblies 34 each include first and second strap members 36a, 36b, respectively, and male and female connector components, 38a, 38b, respectively, secured to the respective straps. The strap members 36a, 36b together define a strap. The straps 36a, 36b of the illustrated embodiment are secured at first end margins to the connectors 22 (more particular the extension members 26, and the connector components 38a, 38b are secured to opposite second end margins of the respective straps. As shown best in FIGS. 5 and 6, each strap member 36a, 36b is secured to a side surface of the respective extension member 26 by a connecting ear 39. Each connecting ear is secured to a respective extension member by a corresponding bolt 39a. To hold the extension member 26 in the stile (FIG. 3), one of the strap members 36b including the associated connector component 38b is wrapped around a lower rung 18 of the ladder 14 and connected to the mateable fastening component 38a of the other strap 36a. The connector components 38a, 38b include buckle devices 40 (FIGS. 5 and 6) for tightening (i.e., shortening) the strap members 36a, 36b around the lower rung 16. One or more buckle devices 40 may be associated with the strap members 36a, 36b in other ways. As one alternate, each strap assembly may comprise a single, unitary strap with the male and female connector components secured at opposite end margins of the strap. Other ways of holding the extension members 26 in the stiles 16 are within the scope of the invention.

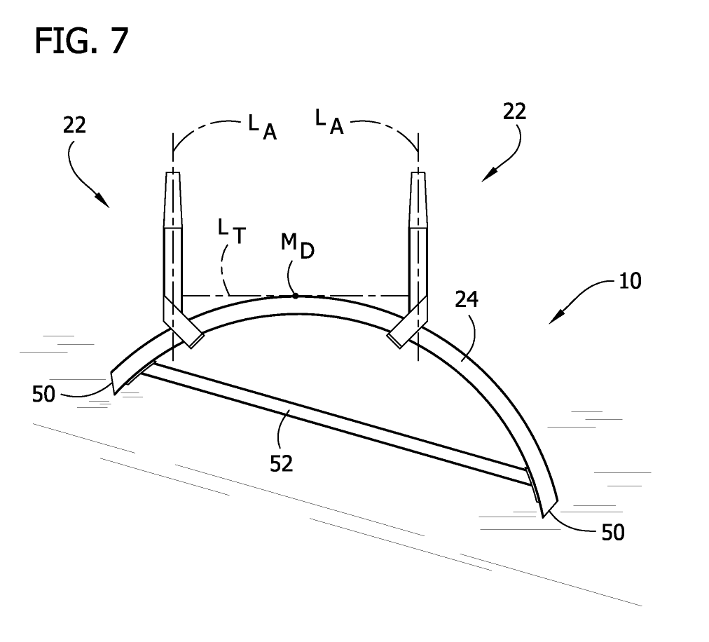

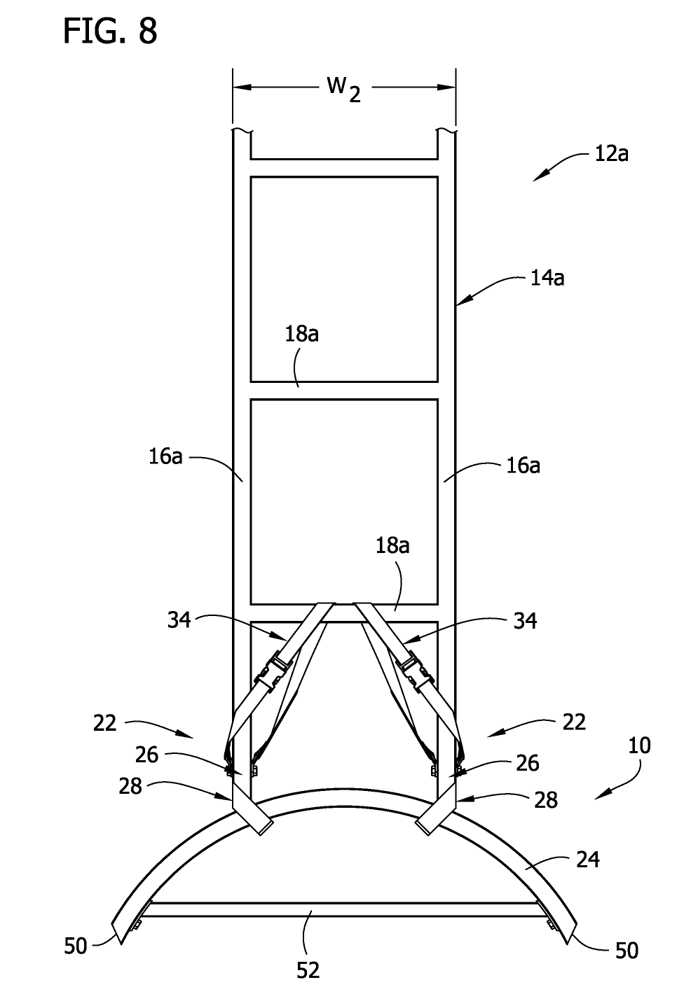

As shown best in FIG. 1, each bracket member 28 slidably connects the respective extension member 26 (and thus the ladder stand) to the arcuate bar 24. Referring to FIG. 5, the bracket member 28 is generally U-shaped having a pair of parallel arms 42. The extension member 26 is secured between free end margins of the arms 42 to define an opening 44 (FIG. 5) through which the arcuate bar 24 extends. The bracket members 28 and the openings 44 defined by the bracket members may be formed in other ways without departing from the scope of the present invention. The opening 44 of the bracket member is sized and shaped to allow sliding movement of the connector 22 along the arcuate bar 24. As illustrated in FIG. 6, the bracket member 28 extends from the extension member 26 at an angle A. As illustrated in FIG. 7, at any position on the arcuate bar 24, the extension members extend generally perpendicular to a line L_{T} tangent to a point MD on the arcuate bar midway between axes L_{A} of the extension members. Through this arrangement along with the size and shape of the arcuate bar 24, the foot apparatus 10 levels the ladder stand 12 on an uneven ground (FIG. 7) and/or allows the ladder to extend at an angle other than perpendicular to the ground. Similarly, through this arrangement the foot apparatus 10 is also configured for use with ladders of different widths. For example, referring to FIG. 8, the foot apparatus 10 is shown attached to a ladder stand 12a including a ladder 14a having a smaller width W2 than a width W1 (FIG. 3) of the ladder 14 of the previous embodiment.

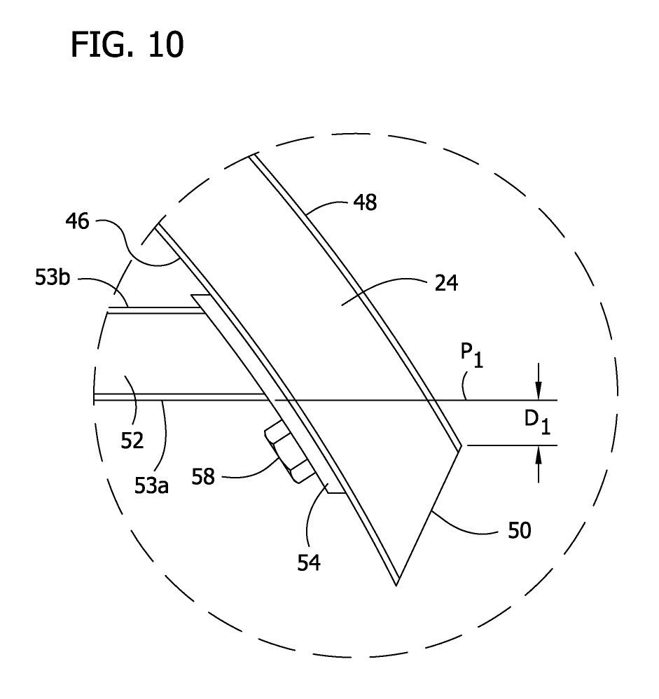

Opposite ends 50 of the arcuate bar 24 engage the ground G during use and the load applied to the arcuate bar is transferred to the ends of the bar. The ends 50 of the arcuate bar 24 are beveled to facilitate penetration of the ends into the ground G (FIG. 3). Penetration of the arcuate bar 24 into the ground G prevents the foot apparatus 10 from moving with respect to the ground during use. More specifically, as shown best in FIG. 10, the ends 50 of the arcuate are beveled from an outer surface 48 to an inner surface 46 of the bar 24, although it is understood that the ends may be beveled from the inner surface to the outer surface. Beveling the ends 50 from the outer surface 48 to the inner surface 46 forces the ends of the arcuate bar 24 inward, as opposed to laterally outward, when the ends are forced into the ground G. The ends 50 of the arcuate bar 24 may take on other shapes without departing from the scope of the invention.

The arcuate bar 24 has a generally rectangular cross-section. As stated above, the arcuate bar 24 is sized and shaped to accommodate ladders having different widths. For example, in the illustrated embodiment, the distance between the opposite ends of the bar is about 22 in (56 cm) and a uniform radius of curvature of about 24 in (61 cm). The arcuate bar 24 may be formed from bar stock, such as bar stock having a rectangular cross-section. Other dimensions are possible within the scope of the present invention.

As illustrated throughout the drawings, a hollow cross bar 52 is secured to the inner surface 46 of the arcuate bar 24 generally adjacent to the ends 50 of the arcuate bar to provide structural support to the arcuate bar during use. More specifically, the cross bar 52 prevents the ends 50 of the arcuate bar 24 from bending toward or away from each other. Ends of the cross bar 52 are disposed above the respective proximate ends 50 of the arcuate bar 24 about the same distance. Stated another way and shown in FIG. 10, a bottom surface 53a of the cross bar 52 lies in a plane P1, and substantially the entirety of the plane is disposed a distance D1 above the beveled ends 50 of the arcuate bar 24. Through this arrangement, in addition to providing support, the cross bar 52 acts as a stop that limits the penetration of the beveled ends 50 of the arcuate bar 24 into the ground G. The cross bar 52 can also function as a leveraging device for driving the beveled ends 50 of the arcuate bar 24 into the ground G. For example, the user may step on the cross bar 52 to drive the beveled ends 50 of the arcuate bar 24 into the ground G.

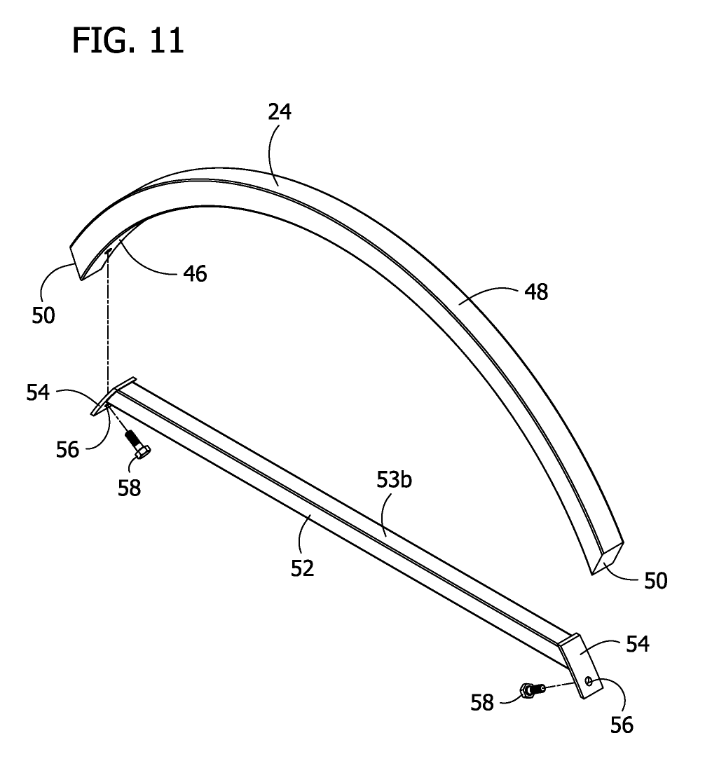

As shown best in FIGS. 10 and 11, the ends of the cross bar 52 are angled to generally conform to a curvature of the inner surface 46 of the arcuate bar 24 so that the ends of the cross bar are seated generally flush against the inner surface of the arcuate bar. More specifically, the ends of the cross bar 52 are beveled from an upper surface 53b to the bottom surface 53a of the cross bar. The cross bar 52 also includes flaps 54 extending downward from the ends of the cross bar 52. The flaps 54 define fastener openings 56 for receiving bolts 58 to secure the cross bar 52 to the arcuate bar 24. The flaps 54 are also angled to conform to the curvature of the inner surface 46 of the arcuate bar 24. Other ways of securing the cross bar 52 to the arcuate bar 24 are within the scope of the invention.

The cross bar 52 may be formed from hollow bar stock, such as hollow bar stock having a rectangular cross-section. The flaps 54 may be welded or otherwise secured to the ends of the arcuate bar 52.

In an exemplary use, a user slides the connectors 22 along the arcuate bar 24 so that the extension members 26 are generally aligned with the cavities 20 in the stiles 16. The tapered portions 30 of the extension members 26 are then inserted into the open bottoms of the stiles 16. The user then wraps the strap members 36a around the lower rung 18 of the ladder 16 and snaps the male components 38a into the corresponding female components 38b of the other strap members 36b. The user may then tighten the strap members 36a, 36b using the buckle devices 40. The ladder stand 12 is then raised to extend along the height of the tree T. The beveled ends 50 of the arcuate bar 24 are driven into the ground G by stepping on the cross bar 52. Next, the angle at which the ladder stand 12 extends from the ground G may be adjusted by sliding the connectors 22 along the arcuate bar 24. The ladder stand 12 is then secured to the tree T. Other procedures for using the foot apparatus 10 may be employed within the scope of the present invention.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A foot apparatus for a ladder stand, the foot apparatus comprising:
an arcuate bar having opposite ends for engaging a support surface;
at least one connector slidably secured to the arcuate bar for connecting the arcuate bar to a bottom portion of the ladder stand, the connector being slidable along the arcuate bar so that when the foot apparatus is attached to the ladder stand, the ladder stand extends at a selected angle with respect to the support surface,
a cross bar having opposite ends secured generally adjacent to said opposite ends of the arcuate bar.

2. A foot apparatus as set forth in claim 1 wherein the arcuate bar has an inner surface, and wherein the opposite ends of the cross bar are secured to the interior surface of the arcuate bar.

3. A foot apparatus as set forth in claim 2 wherein each of the opposite ends is connected to the arcuate bar at about the same distance from the proximate ends of the arcuate bar.

4. A foot apparatus as set forth in claim 2 wherein the ends of the cross bar are shaped to conform to a curvature of the interior surface of the arcuate bar.

5. A foot apparatus as set forth in claim 1 wherein the opposite ends of the arcuate bar are shaped to facilitate penetration of the ends into the support surface.

6. A foot apparatus as set forth in claim 5 wherein a lower surface of the cross bar lies in a plane that is directly above the beveled ends whereby the cross bar is arranged to act as a stop to limit penetration of the ends into the support surface.

7. A foot apparatus as set forth in claim 1 in combination with a ladder stand.

8. A foot apparatus for a ladder stand, the apparatus comprising:
an arcuate bar having opposite ends;
at least one connector slidably secured to the arcuate bar for connecting the arcuate bar to a bottom portion of the ladder stand, the connector being slidable along the arcuate bar so that when the foot apparatus is attached to the ladder stand, the ladder stand extends at a selected angle with respect to the support surface;
the opposite ends of the arcuate bar being shaped to penetrate a supporting surface.

9. A foot apparatus as set forth in claim 8 wherein the opposite ends of the arcuate bar are beveled.

10. A foot apparatus as set forth in claim 9 wherein the ends of the arcuate bar are beveled from an outer surface of the bar to an inner surface of the bar.

11. A foot apparatus as set forth in claim 8 in combination with a ladder stand.

12. A foot apparatus for a ladder stand of the type including a pair of stiles each having an axial cavity formed in at least a bottom portion thereof, the foot apparatus comprising:
an arcuate bar;
a pair of connectors for securing the arcuate bar to a bottom portion of the ladder stand, each connector including a bracket member for being secured to the arcuate bar for selective sliding movement along the bar, and an extension member extending from the bracket member and being sized and shaped to be received in the cavities of the bottom portions of the stiles of the ladder stand.

13. A foot apparatus as set forth in claim 12 wherein each extension member has a first portion including a free end of the extension member that tapers toward the free end of the extension member to facilitate insertion of the extension member in the axial cavity of the bottom portion.

14. A foot apparatus as set forth in claim 13 wherein each extension member further has a second portion immediately adjacent to the first portion, the second portion being sized and shaped to act as a stop to prevent substantial insertion of the second portion into the axial cavity of the bottom portion.

15. A foot apparatus as set forth in claim 14 wherein the second portion has a cross-section larger than a cross-section of the axial cavity.

16. A foot apparatus as set forth in claim 12 further comprising a fastening device for releasably securing the extension members in the axial cavities of the bottom portions of the stiles.

17. A foot apparatus as set forth in claim 16 wherein the fastening device comprises at least one strap assembly adapted to wrap around a lower rung of the ladder stand to hold the extension members in the axial cavities.

18. A foot apparatus as set forth in claim 17 wherein the strap assembly comprises a first strap member having a first end margin secured to one of the extension members and a first connector component secured to a second end margin of the first strap member, and a second strap member having a first end margin secured to the extension member and a second connector component secured to a second end margin of the second strap member, the second connector component being releasably mateable with the first connector component.

19. A foot apparatus as set forth in claim 18 wherein the strap assembly constitutes a first strap assembly, the fastening system further comprising a second strap assembly comprising a first strap member having a first end margin secured to one of the extension members and a first connector component secured to a second end margin of the first strap, and a second strap member having a first end margin secured to the extension member and a second connector component secured to a second end margin of the second strap member, the second connector component being releasably mateable with the first connector component.
